(19) United States
(12) Patent Application Publication
(10) Pub. No.: US 2013/0257906 A1
(43) Pub. Date: Oct. 3, 2013

(54) Generating publication based on augmented reality interaction by user at physical site

(71) Applicants: Feng Tang, Mountain View, CA (US); Qian Lin, Santa Clara, CA (US); Daniel R. Tretter, San Jose, CA (US)

(72) Inventors: Feng Tang, Mountain View, CA (US); Qian Lin, Santa Clara, CA (US); Daniel R. Tretter, San Jose, CA (US)

(21) Appl. No.: 13/436,838

(22) Filed: Mar. 31, 2012

(51) Int. Cl. G09G 5/377

(52) U.S. Cl. 345/633

(57) ABSTRACT

Interaction data represents augmented reality interaction by a user using a mobile computing device with physical points of interest at a physical site. A publication is generated based on this interaction data and provided to the user.

### BACKGROUND

A common activity that tourists engage in is visiting physical sites like museums. A museum may have a number of physical points of interest, such as separate rooms and groupings of artwork. At each physical point of interest, there may be a number of physical objects that a tourist can view, such as individual paintings, sculptures, and so on. Traditionally, a physical site like a museum has relied upon printed placards or their electronic equivalents like permanently affixed touchscreen devices to convey information regarding its physical objects to tourists.

### BRIEF DESCRIPTION OF THE DRAWINGS

FIG. 1 is a diagram of a representative physical site having physical points of interest in relation to which an example of the disclosure is described.

FIG. 2 is a flowchart of an example method of the disclosure.

FIG. 3 is a flowchart of an example method that is more detailed than but consistent with the method of FIG. 2.

FIG. 4 is a diagram of an example mobile computing device and an example computing system in which a publication is generated based on a user's augmented reality interaction at a physical site.

### DETAILED DESCRIPTION

As noted in the background section, users like tourists may visit physical sites like museums that have physical points of interest. Printed placards or their electronic equivalents have traditionally conveyed information regarding these physical points of interest, such as physical objects located at the physical points of interest, to the users. More recently, some physical sites like museums have relied upon audio and video devices that users can borrow (or may own) to convey information. For instance, in general, a placard at a physical point of interest may inform the user to press a corresponding code on such a device to learn more information.

Once a user concludes a visit to physical site, however, he or she is left with few ways to remember the visit. The user may have taken photographs or recorded video that can be reviewed later, although many physical sites discourage or even prohibit the use of recording devices in this manner. The user may be afforded the opportunity to purchase a guidebook or tour guide regarding the physical site, but which presents non-personalized information to the user. The user may access the web site for the physical site on the Internet, although the amount of information conveyed in this manner may be limited and geared more towards prospective visits than past visits to the site.

Techniques disclosed herein provide for advantages over these existing approaches. As a user visits physical points of interest at a physical site, he or she can interact with the physical points of interest—such as physical objects thereat—in an augmented reality manner. For example, a user may have a computer program, such as what is commonly referred to as an “app,” installed on his or her smartphone or other mobile computing device. The user may point a camera of the device at a physical object within a particular physical point of interest to capture a photo or video of the object. The captured visual information may be processed to generate a feature or signature describing the visual content. This signature is then used to recognize which object of interest the user is viewing. Global positioning system (GPS) or other location information may assist in pinpointing the user at this physical point of interest.

The computer program can transmit the picture, or the identity of the physical object, along with the location information to a computing device, which in return transmits information regarding the physical object or the physical point of interest back to the mobile computing device. This information may include text, video, and images regarding the physical object, for instance. The user can then access and browse the information on his or her mobile computing device. The reality of the user—i.e., the physical presence of the user at the physical point of interest—is thus said to be augmented via this information.

The mobile computing device transmits to the computing device interaction data representing this augmented reality interaction. For instance, besides the location and other information previously transmitted by the mobile computing device, the interaction data can include which of the information that was sent back to the mobile computing device the user actually accessed, and so on. As an example, for a group of paintings, a user may have accessed information regarding the style and genre of the paintings but not any information regarding their painters.

Based on this interaction data, the computing device generates a publication. The computing device may supplement the information the user accessed with further information that was not previously conveyed to the user, based on the interaction data. In the previous example, since the user was most interested in the style and genre of the paintings, this information may be supplemented with additional information regarding style and genre, but not with further information regarding the painters of the paintings. The publication can include at least a portion of the information that the user had previously accessed, as well as this supplemental information.

The publication can be a printed publication, or an electronic publication. The publication can even be a virtual augmented reality recreation of the user's visit at the physical site. The user is provided with the publication, such as at the conclusion of his or her visit to the physical site. Because the publication is based on the user's personal interaction with the physical points of interest at the physical site, the publication is personalized to the user's visit. The user thus is able to relive his or her experience by reviewing the publication.

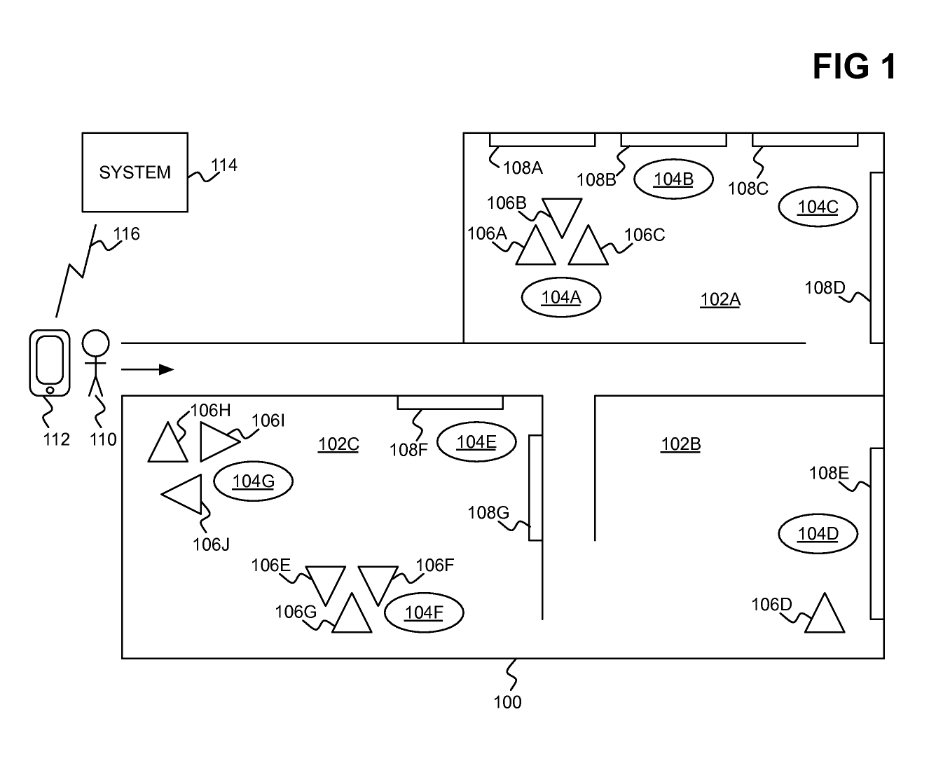

FIG. 1 shows a representative physical site 100, such as a museum, in relation to which an example of the disclosure is described. The physical site 100 includes rooms 102A, 102B, and 102C, which are collectively referred to as the rooms 102. The rooms 102 include physical points of interest 104A, 104B, 104C, 104D, 104E, 104F, and 104G, which are collectively referred to as the physical points of interest 104. The physical points of interest 104 include physical objects 106A, 106B, 106C, 106D, 106E, 106F, 106G, 106H, 106I, and 106J, such as sculptures, and which are collectively referred to as the physical objects 106. The physical points of interest 104 also include physical objects 108A, 108B, 108C, 108D, 108E, and 108F, such as paintings, and which are collectively referred to as the physical objects 108.

Specifically, the physical point of interest 104A includes the physical objects 106A, 106B, and 106C, and the physical point of interest 104B includes the physical objects 108A, 108B, and 108C. The physical point of interest 104C includes the physical object 106C, whereas the physical point of interest 104D includes the physical objects 106D and 108E. The physical point of interest 104E includes the physical objects 108F and 108G, the physical point of interest 104F includes the physical objects 106E, 106F, and 108G, and the physical point of interest 104G includes the physical objects 106H, 106I, and 106J.

The physical site 100 is a physical site in that it is an actual place, location, venue, and so on, which a user 110 can visit in person, as opposed to a virtual site that a user just virtually visits through a computing device, such as an Internet web site. Similarly, the physical points of interest 104 are points of interest that the user 110 can actually visit in person. A physical site 100 includes a number of such physical points of interest 104. Each physical point of interest can include a number of physical objects 106 and/or 108, for viewing by the user 110.

The user 110 has a mobile computing device 112 that has communication capability with a computing system 114, as represented by the lightning bolt 116. An example of such a mobile computing device 112 is a smartphone. The user 110 uses the mobile computing device 112 to interact with the physical points of interest 104 of the physical site 100—such as the physical objects 106 and 108 located thereat—in an augmented reality manner. Interaction data regarding this augmented interaction reality is reported to the computing system 114, which generates a publication based on the interaction data.

The user 110 may follow a personal path through the points of interest 104 of the physical site 100. For example, the user may first visit the room 102A, but bypass the physical points of interest 104B and 104C to focus on the physical point of interest 104A. The user 110 may use a computer program on the mobile computing device 112 to request information on each of the physical objects 106A, 106B, and 106C at this physical point of interest 104A. After spending a brief time reviewing the sculptor of each physical object 106A, 106B, and 106C, for instance, the user 110 may then travel to the room 102B.

Within the room 102B, the user 110 may proceed to the physical point of interest 104D, but focus solely on the physical object 106D, foregoing attention of the physical object 108E. The user 110 may again use the mobile computing device 112 to request information on the physical object 106D. The user 110 may be particularly interested in this physical object 106D, specifically in its sculptor, and spend a lengthy amount of time at the physical point of interest 104D. The user 110 may then conclude his or her visit of the physical site 100, without ever having visited the room 102C or its physical points of interest 104E, 104F, and 104G.

The mobile computing device 112 reports to the system 114 which information the user 110 accessed regarding the physical objects 106A, 106B, and 106C at the physical point of interest 104A, and which information the user accessed regarding the physical object 106D at the physical point of interest 104D. Furthermore, the number of times or the length of time the user 110 accessed the information regarding the physical objects 106A, 106B, and 106C and the physical object 106D can be reported to the system 114. The mobile computing device 112 may also report its location to the system 114 within the physical site 100.

Based on this and other interaction data, the system 114 discerns the behavior and interest of the user 110 as they pertain to the physical site 100. For example, the user 110 does not appear to be interested in paintings, but rather appears to be interested in just sculpture, since the user accessed information just on the objects 106A, 106B, 106C, and 106D, and not on any of the objects 108. The user 110 appears to be most interested in the object 106D, having spent the largest amount of time reviewing information regarding this object 106D.

The user 110 also does not appear to be interested in any of the physical points of interest 104E, 104F, and 104G within the room 102C, since the user 110 forewent entry into the room 102C. If the rooms 102A and 102B showcase modern art, whereas the room 102C showcases Renaissance art, the system 114 can glean that the user is most interested in modern art. Furthermore, since the user 110 accessed information just regarding the sculptors of the physical objects 106A, 106B, 106C, and 106D, the user 110 appears to be most interested in the sculptors, as opposed to the techniques and styles, of these objects.

Based on this interaction data and the conclusions drawn therefrom, then, the system 114 generates a publication that is personalized to the user 110's personal experience at the physical site 100. The majority of the publication may be focused on the sculptor of the physical object 106D, since the user 110 had spent the most time reviewing this information. The publication may include more supplemental information regarding the sculptors of the physical objects 106A, 106B, 106C, and 106D than information regarding the sculptures themselves, since the user 110 did not review information regarding the sculptures themselves. The publication may further include background information regarding modern art, but not include any information regarding Renaissance art.

The publication is thus particular to the user 110's visit of the physical site 100. A different user visiting different of the physical points of interest 104 and/or focusing his or her attention differently within the physical site 100 would thus receive a generated publication unlike that of the user 110. The publication may be in electronic form that the system 114 transmits to the mobile computing device 112 for presentation to the user 110. The publication may be in paper form, such as a book, that the user 110 may be given or have the opportunity to purchase. The publication may be a virtual augmented reality recreation of the user 110's visit, permitting him or her to relive the experience without having to travel back to the physical site 100.

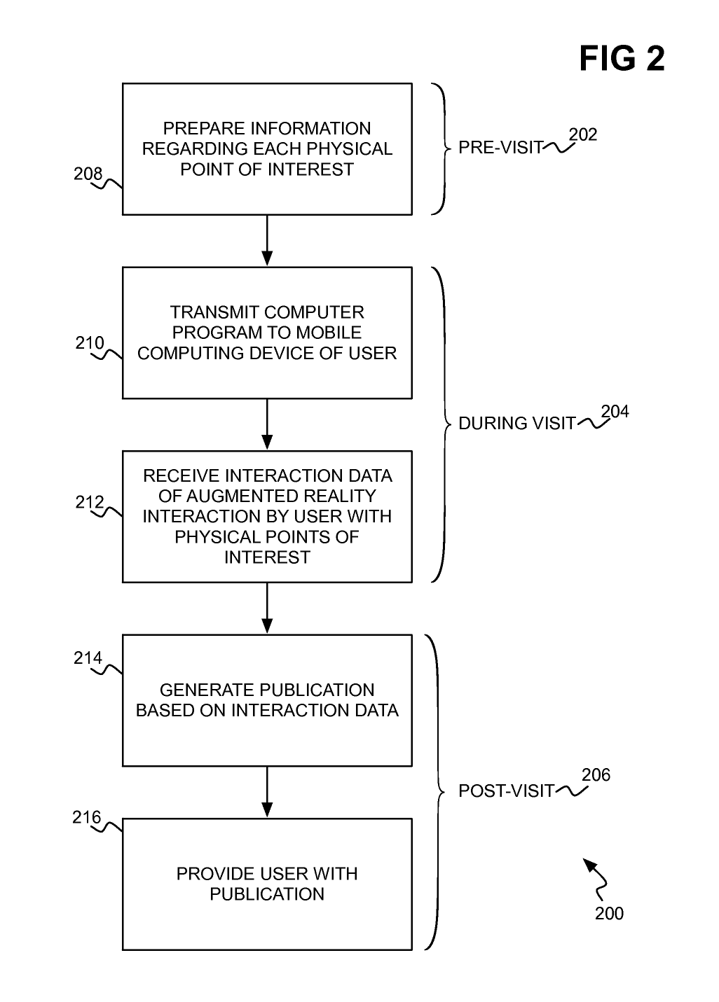

FIG. 2 shows an example method 200. The method 200 is performed by, at, or in conjunction with a computing system like the system 114. Parts 208, 210, 212, 214, and 216 can be performed at different times in relation to the user 110's trip to the physical site 100: before the visit, per reference number 202; during the visit, per reference number 204; and after the visit, per reference number 206. Part 210 may be performed either prior to or during the user 110's visit to the physical site 100. In some implementations, part 210 may be performed prior to the user 110's visit instead of during the visit as indicated in FIG. 2.

The information regarding each physical point of interest 104 is prepared (208). For instance, information regarding each physical object 106 and 108 at each physical point of interest 104 may be acquired and assembled in a form viewable at the mobile computing device 112. This information can include text, image, audio and video information, among other types of information. Where the physical objects 106 and 108 are artwork, the information may include information regarding each physical object 106 and 108 itself, information regarding the sculptor of each physical object 106 and 108, information regarding the techniques and historical relevance of each physical object 106 and 108, and so on.

A computer program, such as an “app,” is transmitted to the mobile computing device 112 of the user 110 (210). The computer program may be transmitted during or prior to the user 110's visit of the physical site 100. The computer program permits the mobile computing device 112 to retrieve the information prepared in part 208 for a particular point of interest 104 when the user is physically present at this point of interest 104. The computer program further transmits interaction data back to the system 114.

The interaction data can include what information the user 110 actually reviewed on the mobile computing device 112. The interaction data can include which physical points of interest 104 and the length of time the user 110 was located at each physical point of interest 104, such as via location information of the mobile computing device 112. The interaction data can include the number of times the user 110 visited each physical point of interest 104, and the path the user took through the physical points of interest 104.

The system 114 thus receives this interaction data during the user 110's trip to the physical site 100 (212). On the basis of this interaction data, the system 114 generates a publication (214). As noted above, the publication may be a printed publication, an electronic publication, and/or a virtual augmented reality recreation of the user 110's trip, among other types of publications. The user is then provided with the publication (216), which can include transmitting an electronic publication to the mobile computing device 112 of the user 110 for access and viewing by the user 110.

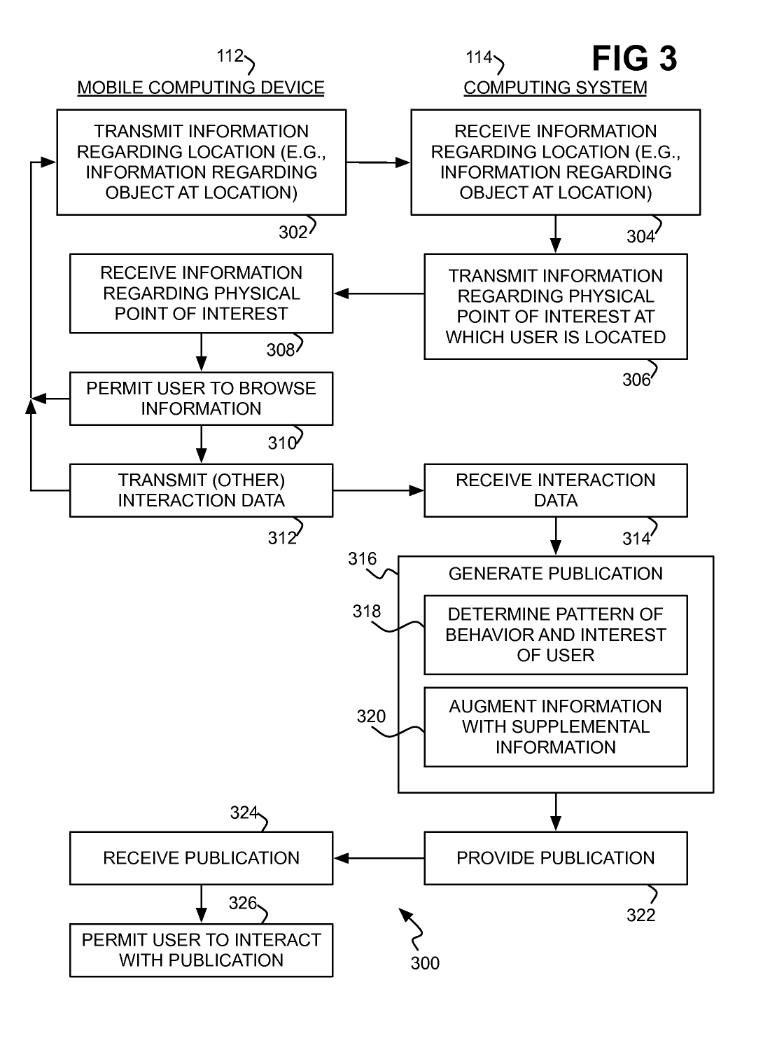

FIG. 3 shows an example method 300 that is more detailed than but consistent with the method 200. The method 300 is divided into a left column and a right column. The mobile computing device 112 performs parts of the method 300 within the left column. The computing system 114 performs parts of the method 300 within the right column. The mobile computing device 112 and the computing system 114 communicate with one another over a network, such as the Internet, a local-area network, and so on.

When the user 110 is located at a particular physical point of interest 104, the mobile computing device 112 transmits information regarding the location of the user 110 to the computing system 114 (302), which receives this information (304). The location information can be or include information regarding a physical object 106 or 108 at the physical point of interest 104 and that is of interest to the user 110. Such physical object information can include visual information regarding the physical object 106 or 108 that the user is viewing, such as a picture or a video thereof. Other types of location information can include that provided by the mobile computing device 112 where the device 112 has GPS or other functionality by which it may periodically and automatically transmit such information to the computing system 114.

For instance, the user 110 may use the mobile computing device 112 to indicate and denote that he or she is located at a particular physical point of interest 104. Such usage may be explicit, where the user 110 informs the mobile computing device 112 where he or she is. Such usage may also be implicit. For example, the user 110 may use a camera of the mobile computing device 112 to record an image of a physical object 106 or 108 at the particular physical point of interest 104. The system 114 knows beforehand which physical objects 106 and 108 are located at which physical points of interest 104, and thus based on this predetermined information can then determine the user 110's location by recognizing and identifying the physical object 106 or 108 within the image. That is, the captured visual information (i.e., the picture or video of the physical object 106 or 108) is processed to generate a feature or signature describing the visual content, on which basis the object 106 or 108 is recognized.

The information regarding the location of the user 110 can be thus said to encompass a request sent via the mobile computing device 112 to the computing system 114 for information regarding the particular physical point of interest 104 at which the user 110 is located. The request may be for information regarding a physical object 106 or 108 within the particular physical point of interest 104 at which the user 110 is located. The request may also be more generally regarding the particular physical point of interest 104 as a whole.

The computing system 114 in response transmits information regarding the particular physical point of interest 104 at which the user 110 is located back to the mobile computing device 112 (306), which receives this information. Where the request was particular to a specific physical object 106 or 108, the information transmitted back to the mobile computing device 112 may itself be particular to this physical object 106 or 108. The mobile computing device 112 permits the user 110 to browse, access, view, and/or interact with this information in an augmented reality manner (310). That is, the reality of the user being physically present at the physical point of interest 104 is augmented with this information.

The information transmitted in part 302 from the mobile computing device 112 to the computing system 114 is part of interaction data representing the user 110's augmented reality interaction of the user, via the mobile computing device 112, with the physical points of interest 104 of the physical site 100. As the user 110 browses and interacts with the information received in part 308, the mobile computing device 112 tracks the user's 110 browsing of this information, and this interest data (i.e., which information the user is interested in, how the user interacted with this information, and so on) is itself part of the interaction data, too. Other interaction data includes, as noted above, which physical points of interest 104 the user 110 has visited, the length of time and the number of times the user 110 was at each physical point of interest 104, the path the user 110 took to travel through the physical points of interest 104, and so on.

From part 310, the method 300 can proceed back to part 302 as the user 110 moves among the physical points of interest 104 and/or among different physical objects 106 and 108 within the physical points of interest 104. As such, parts 302, 304, 306, and 308 can be repeated a number of times during the user 110's visit of the physical site 100. In this scenario, once the user 110 has finished his or her visit, the interaction data other than the information transmitted in part 302 is transmitted to the computing system 114 (312), which receives this other interaction data at that time (314).

In another usage scenario, the other interaction data may be periodically transmitted from the mobile computing device 112 to the computing system 114 (312), such that the method 300 at least sometimes proceeds from part 310 to part 312. However, in this usage scenario, the method 300 can still proceed back from part 312 to part 302. In this usage scenario, then, the other interaction data is transmitted on a more piecemeal basis, periodically and/or as this other user interaction data is acquired, whereas in the former usage scenario of the previous paragraph, the other interaction data is transmitted on a batch basis at the end of the user 110's visit to the physical site 100.

By receiving the interaction data, the computing system 114 is said to collect this interaction data representing the user 110's augmented reality interaction with the physical points of interest 104 of the physical site 100, and corresponding to the information requested and accessed at each physical point of interest 104 in question (314). At some point at the conclusion of the user 110's visit of the physical site 100, the computing system 14 generates a publication based on the interaction data (316). As has been noted, the publication can be a printed publication, an electronic publication, or even a virtual augmented reality recreation of the user's visit of the site 100.

In one implementation, generating the publication can include either or both of the following. The pattern of the user 110's behavior, and the interest of the user 110, in relation to the physical points of interest 104 can be determined (318). For example, data mining, statistical, probabilistic, analytical and/or other techniques can be employed in relation to the interaction data. Such techniques provide a better insight to what the user was most interested in when visiting the physical site 100. The publication is then generated using this pattern of behavior and/or user interest, to provide a more personalized publication that is likely to be better received by the user 110.

The information that was received in part 308 and that the user 110 accessed in part 310 may also be augmented with supplemental information based on the interaction data. As noted above, for instance, if a user is more interested in the sculptors of sculptures than the sculptures themselves, the additional information can include further historical and personal information regarding the sculptors. Data mining, statistical, probabilistic, analytical, and/or other techniques can also be employed to determine which supplemental information should be used to augment the information that the user 110 accessed in part 310.

The publication thus can include the information that was received in part 308 and that the user 110 accessed in part 310, as well as this supplemental information. How the publication is laid out, and the extent to which the information is included in the publication where there is a maximum amount of information that can be included, can be made on the basis of various techniques as well. For example, a probabilistic document model (PDM) can be employed to lay out the information in accordance with the user 110's pattern of behavior and interest in the information. This also results in a personalized publication that is likely to be better received by the user 110.

Where the publication is or includes a virtual augmented reality recreation of the physical site 100, a three-dimensional virtual world of the site 100 may be part of the publication, and which the user 110 can then interaction with via the mobile computing device 112 or another computing device. This virtual world is augmented with the information that the user previously accessed in part 310 and with the supplemental information determined in part 320. For instance, a user may be able to navigate the virtual world to locate a desired physical object 106 or 108 of interest within a particular point of interest 104, and then view information regarding this object 106 or 108, using his or her computing device.

The computing system 114 provides the publication to the user 110 (322). It is contemplated that the user 110 may be able to purchase the publication, either separately or as part of a package that includes an admittance ticket to the physical site 100. The user 110 may further be able to receive the publication for free, especially where the publication is provided in electronic form. The publication serves to enhance the user 110's visit of the physical site 100, and also may serve as incentive for the user 110 to visit the site 100 in the first place.

The user 110 receives the publication (324), and can interact or otherwise view the publication (326). The user 110 may interact with the publication in an augmented reality manner regardless of whether it is in physical or electronic form. For instance, when in electronic form, the publication may include a virtual augmented reality recreation of the physical site 100. When the publication is in physical form, the user 110 may be able to use a mobile computing device 112 to interact with the publication no differently than when the user 110 had interacted with the actual physical objects 106 and 108 at the physical site 100. In both cases, such a virtual augmented reality recreation is virtual in the sense that the user 110 does not interact with the actual physical site 100 but rather with a virtual recreation thereof. The recreation is an augmented reality recreation in that the virtual recreation is augmented with other information not found in the physical site 100 itself.

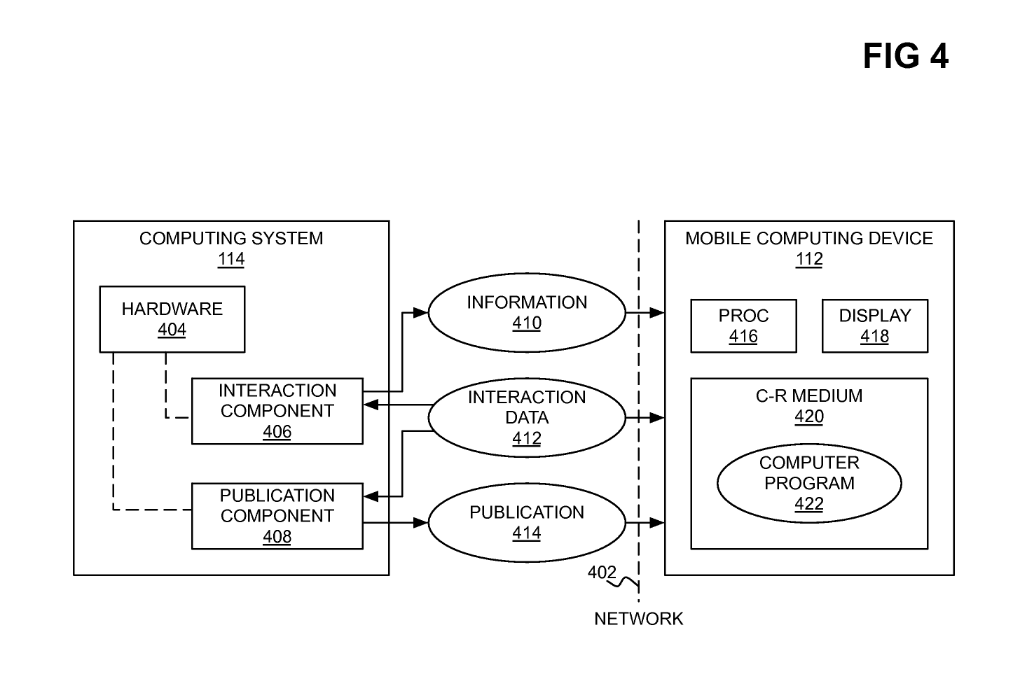

FIG. 4 shows the computing system 114 and the mobile computing device 112 in example detail. The computing system 114 and the mobile computing device 112 interact with one another over a network 402. The network 402 may be or include the Internet, an intranet, an extranet, a local-area network, a wide-area network, a mobile communication network like a third generation (3G) or a fourth generation (4G) communication network, and so on.

The computing system 114 can be implemented over one or more computing devices, like server computing devices and other types of computers. The computing system 114 includes hardware 404, and an interaction component 406 and a publication component 408 that are said to be implemented at least by the hardware 404. For example, the components 406 and 408 may be software that runs on or using the hardware 404. The hardware 404 can include one or more processors, memory, storage devices, network adapters, and other types of hardware.

The interaction component 406 performs parts 304 and 306 of the method 300 that has been described. As such, the interaction component 410 receives interaction data 412, in the form of information regarding the location of the mobile computing device 112, in part 304, and in response provides the information 410 in part 306. The publication component 408 performs parts 314, 316, and 322 of the method 300. As such, the publication component 408 receives the same (and other) interaction data 412 in part 314, generates the publication 414 in part 316, and provides the publication in part 322.

The mobile computing device 112 can be a smartphone or another type of mobile computing device. The mobile computing device 112 includes at least a processor 416, a display 418, and computer-readable medium 420. The computer-readable medium 420 can be a non-transitory computer-readable data storage medium, like a volatile or non-volatile semiconductor memory or other type of storage device, such as a magnetic storage device like a hard disk drive.

The computer-readable medium 420 stores a computer program 422 that the processor 416 executes. Execution of the computer program 422 by the processor 416 results in performance of parts 302, 308, 310, 312, 324, and 326 of the method 300 that has been described. As such, the mobile computing device 112 transmits the interaction data 412 in parts 302 and 312, receives the information 410 in part 308, and permits the user to browse or interact with the information 410 in part 310. The mobile computing device 112 further, where the publication 414 is in electronic form, can receive the publication 414 in part 324 and permit the user to interact with the publication 414 in part 326.

The techniques disclosed herein pertaining to generation a publication based on augmented reality interaction by a user at a physical site have been described primarily in relation to a physical site that is a museum. However, these techniques are also applicable to other physical sites that have physical places of interest that may include collections of one or more physical objects. For instance, the techniques are applicable to tourist sites other than museums. Other types of physical sites in relation to which the techniques disclosed herein can be implemented include trade shows, shopping locations like stores and malls, and so on.

For example, in the context of a trade show or shopping situations, the publication that is generated for the user can include personalized information regarding the products that the user has shown the most interest. Trade shows can include a large number of vendors showcasing their products. A user may only have shown interest in certain vendors and in certain types of products. As such, the publication that is generated can be geared towards these vendors and products. Similarly, when a user visits a “big box” retail store or a location like a shopping mall, the user may have shown interest in just certain products or certain types of products, for which personalized information can be included in the publication that is generated.

Another example in relation to which techniques disclosed herein can be applied is in the context of shopping for real estate. A user may be shown a large number of potential houses, but may have spent most of his or her time interested in a relatively small number of such properties. The publication that is generated for the user can include information that disproportionately focuses on these properties, for instance. The information that is included in the publication can include detailed background information regarding the properties of interest, such as school information, crime rates, and so on, to assist the user in making an informed decision as to which house to purchase.

We claim:

1. A method comprising:
receiving, by a system including a computing device, interaction data representing augmented reality interaction by a user using a mobile computing device with a plurality of physical points of interest at a physical site, the interaction data generated at and received from the mobile computing device, the system not including the mobile computing device;
in response to receiving the interaction data, generating, by the system, a publication based on the interaction data; and
providing the user with the publication that has been generated based on the interaction data.

2. The method of claim 1, wherein receiving the interaction data comprises, as the user travels to each physical point of interest at the physical site:
receiving indication from the mobile computing device denoting that the user is located at the physical point of interest;
transmitting to the mobile computing device information regarding the physical point of interest for presentation on the mobile computing device; and
receiving interest data from the mobile computing device as to which of the information regarding the physical point of interest the user has accessed at the mobile computing device,
wherein the interest data is part of the interaction data.

3. The method of claim 2, wherein receiving indication from the mobile computing device comprises receiving indication from the mobile computing device denoting that the user is requesting information regarding a particular physical object at the physical point of interest,
and wherein transmitting to the mobile computing device information regarding the physical point of interest for presentation on the mobile computing device comprises transmitting the information regarding the particular physical object at the physical point of interest.

4. The method of claim 1, wherein the interaction data comprises one or more of:
which of the physical points of interest the user visited;
a length of time the user was located at each physical point of interest the user visited;
what information the user accessed regarding each physical point of interest the user visited;
a number of times the user visited each physical point of interest;
a path the user took through the physical points of interest the user visited.

5. The method of claim 1, wherein generating the publication based on the interaction data comprises augmenting information the user accessed regarding each physical point of interest with additional information related to and supplementing the information the user accessed regarding each physical point of interest.

6. The method of claim 1, wherein generating the publication based on the interaction data comprises determining a pattern of behavior and interest of the user in relation to the physical points of interest based on the interaction data,
and wherein the publication is generated based on the pattern of behavior and interest that has been determined.

7. The method of claim 1, wherein generating the publication based on the interaction data comprises generating a virtual augmented reality recreation of a visit of the user at the physical site,
and wherein providing the user with the publication comprises transmitting the virtual augmented reality recreation to the mobile computing device of the user for presentation on the mobile computing device and for interaction by the user at the mobile computing device.

8. The method of claim 1, wherein generating the publication based on the interaction data comprises generating one or more of an electronic publication and a physical publication.

9. A system comprising:
hardware including a processor;
an interaction component implemented at least via the hardware to:
responsive to a request received from a mobile computing device of a user located at a physical point of interest at a physical site, provide information regarding the physical point of interest to the mobile computing device and with which the user is to interact via the mobile computing device in an augmented reality manner;
receive from the mobile computing device which of the information the user accessed at the mobile computing device;
collect interaction data corresponding to the information requested at each of a plurality of physical points of interest at the physical site and which of the information the user accessed at each physical point of interest; and
a publication component implemented at least via the hardware to generate a publication based on the interaction data collected by the interaction data and to provide the publication to the user.

10. The system of claim 9, wherein the publication component is further to supplement the information the user accessed at each physical point of interest with additional information related to the information the user accessed at each physical point of interest.

11. The system of claim 9, wherein the publication component is further to determine a pattern of behavior and interest of the user in relation to the physical points of interest based on the interaction data.

12. The system of claim 9, wherein the publication component is further to generate a virtual augmented reality recreation of a visit of the user at the physical site, and to transmit the virtual augmented reality recreation to the mobile computing device of the user for presentation on the mobile computing device and for interaction by the user at the mobile computing device.

13. The system of claim 9, wherein the interaction data comprises one or more of:
which of the physical points of interest the user visited;
a length of time the user was located at each physical point of interest the user visited;
what information the user accessed regarding each physical point of interest the user visited;
a number of times the user visited each physical point of interest;
a path the user took through the physical points of interest the user visited.

14. A non-transitory computer-readable data storage medium storing a computer program executable by a mobile computing device of a user to perform a method comprising:
transmitting a request to receive information regarding a physical point of interest of a physical site and at which the user is located;
receiving the information regarding the physical point of interest responsive to the request and permitting the user to interact with the information in an augmented reality manner; and
transmitting interaction data corresponding to the information requested at each of a plurality of physical points of interest at the physical site, which of the information the user accessed at each physical point of interest, and how the user accessed the information at each physical point of interest.

15. The non-transitory computer-readable data storage medium of claim 14, wherein the method further comprises:
receiving, responsive to transmitting the interaction data, a virtual augmented reality recreation of a visit of the user at the physical site; and
permitting the user to interact with the virtual augmented reality recreation.
